(19) United States
(12) Patent Application Publication
(10) Pub. No.: US 2021/0221281 A1
(43) Pub. Date: Jul. 22, 2021

(54) VEHICLE ROOFTOP BEACON

(71) Applicant: Gayane Tohikian, Glendale, CA (US)

(72) Inventor: Gayane Tohikian, Glendale, CA (US)

(21) Appl. No.: 16/269,395

(22) Filed: Feb. 6, 2019

(51) Int. Cl. B60Q 1/26; G09F 13/22; F21S 9/03; B60Q 7/00

(52) U.S. Cl. CPC B60Q 1/2611; G09F 13/22; F21Y 2115/10; B60Q 7/00; G09F 2013/222; F21S 9/035

(57) ABSTRACT

A vehicle rooftop beacon for drawing attention to a vehicle from afar. The rooftop beacon includes a base, and a light beacon elevatable above the base by an extendable mast. The base also has at least three support feet to stabilize the rooftop beacon when placed upon a vehicle rooftop. The light beacon is thereby supported high above the vehicle rooftop so that the vehicle is more visible to emergency response vehicles from far away. The base can also include a plurality of side-mounted or edge-mounted lights to further call attention to the vehicle. The rooftop beacon is convenient, portable, and lightweight. The support feet can include magnets or weights to stabilize the rooftop beacon on the vehicle rooftop in windy or stormy conditions. The support feet also can include a soft foot covering, such as rubber, to prevent scratching and slipping off of the surface of the vehicle rooftop.

### FIELD OF THE INVENTION

This invention relates generally to vehicle safety equipment, and particularly to roadside emergency equipment.

### BACKGROUND OF THE INVENTION

For a vehicle experiencing roadside distress, such as mechanical failure or simply changing a flat tire, it is common to use the built-in vehicle flashing hazard lights to signal that the vehicle is in distress. However, if the distressed vehicle has a weak battery, the built-in flashing hazard lights will be dim and difficult for other vehicles to see. Additionally, if the vehicle battery has died, the vehicle hazard lights will not function. Therefore, a disabled vehicle may not be visible to other traffic, and may be in danger of being struck by another vehicle, possibly causing injury to the occupants of the vehicle and other roadway travelers.

Furthermore, the distressed vehicle may not be visible to emergency responders, such as police, fire, tow trucks, or AAA roadside assistance personnel.

In an attempt to address this issue, Straten et. al., U.S. Pat. No. 4,952,910 teaches a foldable warning triangle that includes illumination and optional audible alert indicators to warn oncoming vehicles of vehicular accidents and other dangerous conditions. However, this warning triangle is intended to be moved or rolled over the ground, and therefore may not be easily visible to emergency response vehicles from far away.

### SUMMARY OF THE INVENTION

The vehicle rooftop beacon of the invention provides a way to enhance visibility of a distressed vehicle stopped by the side of the road, particularly to make the distressed vehicle more easily and more quickly visible to emergency response vehicles from far away.

The vehicle rooftop beacon includes a highly visible bright beacon that can be elevated high above the rooftop of a vehicle to further enhance visibility of the bright beacon. The based of the vehicle rooftop beacon can also include a plurality of side-mounted and/or corner-mounted lights to enhance the visibility of the vehicle rooftop beacon, thereby further drawing attention to the distressed vehicle. The vehicle rooftop beacon is convenient, portable, and lightweight. The base of the vehicle rooftop beacon of the invention has at least three feet that can include magnets to magnetically attach the vehicle rooftop beacon to the vehicle rooftop so as to stabilize it in windy or stormy weather conditions. The feet also can include a soft foot covering, made from rubber or silicone, so as to resist slipping off of the vehicle rooftop, and to prevent scratching of the surface of the vehicle rooftop.

A general aspect of the invention is a vehicle rooftop beacon for indicating a location and enhancing visibility of a stopped vehicle to a remote approaching emergency vehicle at an earliest possible moment, the stopped vehicle having a rooftop. The vehicle rooftop beacon includes: a light beacon configured to be visible at a remote distance from the vehicle; an extendable mast configured to elevate the light beacon; and a base configured to support the extendable mast, the base having at least three support feet, each of the support feet configured to stabilize the base when placed on the rooftop of the vehicle.

In some embodiments, each of the support feet includes a magnet configured to removably attach the base to the vehicle.

In some embodiments, each of the support feet includes a weight configured to removably attach the base to the vehicle.

In some embodiments, each of the support feet includes a soft covering configured to protect the vehicle rooftop from being scratched.

In some embodiments, each of the support feet includes a rubbery surface configured to resist sliding off the vehicle rooftop and to protect the vehicle rooftop from being scratched.

In some embodiments, the base includes triangular side panels that define a volume within the base.

In some embodiments, the triangular side panels include at least one solar panel for collecting electrical power when exposed to sunlight.

In some embodiments, the triangular side panels are semi-transparent, and the base includes at least one internal light.

In some embodiments, the extendable mast is a telescoping mast.

In some embodiments, the base includes a battery configured to power at least the light beacon.

In some embodiments, the base includes a USB port configured to recharge the battery.

In some embodiments, the base includes a USB port configured to power an external USB device.

In some embodiments, electrical power from the battery to the light beacon is actuated by a switch.

In some embodiments, the light beacon includes a light emitting diode (LED).

In some embodiments, each triangular side panel of the base includes a plurality of lights mounted on an edge of the triangular side panel.

In some embodiments, each triangular side panel of the base includes a plurality of lights mounted between edges of the triangular side panel.

In some embodiments, the base, the extendable mast, and the at least three feet are made of at least one of: metal and plastic.

In some embodiments, the base is shaped as a triangular pyramid.

In some embodiments, the base is shaped as a square pyramid.

In some embodiments, the base is shaped as a hexagonal pyramid.

### BRIEF DESCRIPTION OF THE DRAWINGS

Many additional features and advantages will become apparent to those skilled in the art upon reading the following description, when considered in conjunction with the accompanying drawings, wherein:

FIG. 1A is an isometric side view of the vehicle rooftop beacon, showing a plurality of edge-mounted lights, showing the light beacon in a retracted position, and showing the base having three support feet.

FIG. 1B is a close-up isometric side view of a support foot, showing an embodiment that includes a magnet and a soft foot covering.

FIG. 2 is an isometric side view of the vehicle rooftop beacon of FIG. 1A, showing the telescoping mast in an extended position so as to elevate the light beacon, and also showing a plurality of edge-mounted lights.

FIG. 3 is an isometric side view of the vehicle rooftop beacon of FIG. 1, further including at least one solar panel.

FIG. 4 is an isometric bottom view of the vehicle rooftop beacon of FIG. 1, showing an embodiment that includes a battery, a switch, a USB port, an internal light, and a plurality of edge-mounted lights.

FIG. 5 is a perspective view showing the embodiment of FIG. 1 placed on top of a vehicle stopped along a roadside, with two support feet on the rooftop and one support foot on the rear windshield, showing the telescoping mast in an extended state, and the light beacon and the plurality of edge-mounted lights illuminated so as to facilitate detection and location of the vehicle by an approaching emergency vehicle.

### DETAILED DESCRIPTION

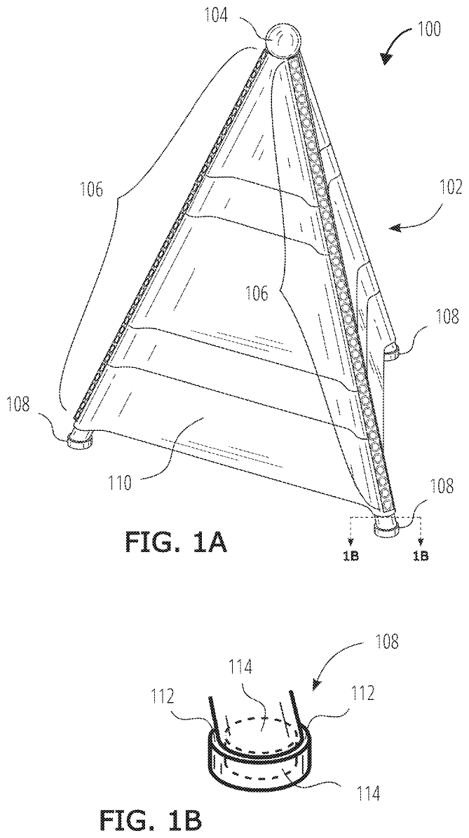

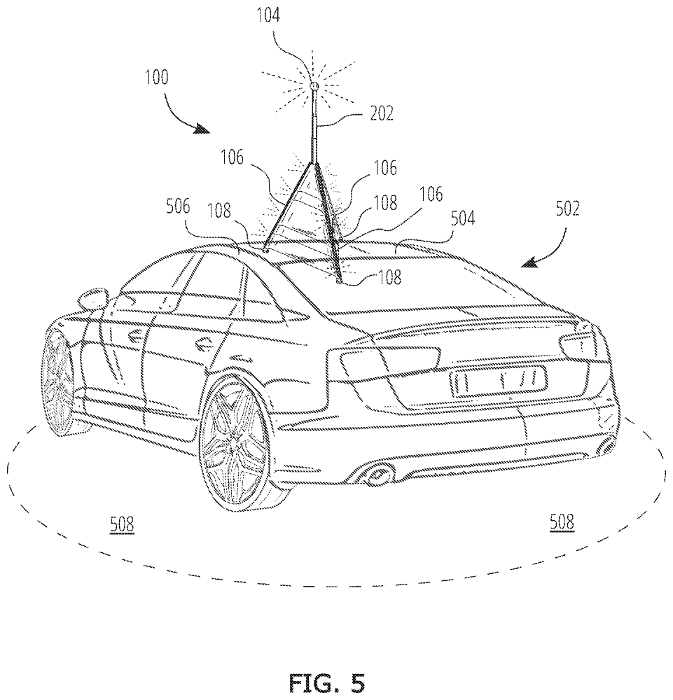

With reference to FIG. 1A, an isometric side view is shown of an embodiment of a vehicle rooftop beacon 100. In this embodiment, the vehicle rooftop beacon 100 includes a base 102 that supports a light beacon 104 and plurality of edge-mounted lights 106. The base 102 also includes triangular side panels 110 and at least three support feet 108 that are configured to be placed upon the rooftop 504 of a vehicle 502 (both shown in FIG. 5).

Preferably, the light beacon 104 is as bright as possible, such as a high-lumen LED (light emitting diode) device. Such a device can include multiple LEDs.

The LEDs can be configured or arranged so as to be visible from a plurality of directions, such as with an omnidirectional bulb.

The plurality of edge-mounted lights 106 can be a plurality of LEDs arranged linearly along an edge of each triangular side panel 110 of the vehicle rooftop beacon 100.

With reference to FIG. 1B, a close-up view is shown of one of the at least three feet 108 that are configured to be placed upon the rooftop 504 of a vehicle 502 (both shown in FIG. 5).

In this embodiment, the at least three support feet 108 include a soft foot covering 112 to prevent scratching to a vehicle surface 506 of a vehicle 502 (both shown in FIG. 5). The at least three support feet 108 also include magnets 114 to removably attach to the vehicle surface 506 to maintain the position of the vehicle rooftop beacon 100 upon the rooftop 504 (shown in FIG. 5) in windy and stormy weather conditions. The at least three support feet 108 can also include suction cups (not shown) to removably but securely adhere to the vehicle surface 506. The at least three support feet 108 can also include weights, such as made from lead, so as to maintain the position of the vehicle rooftop beacon 100 upon the rooftop 504 (shown in FIG. 5) in windy and stormy weather conditions.

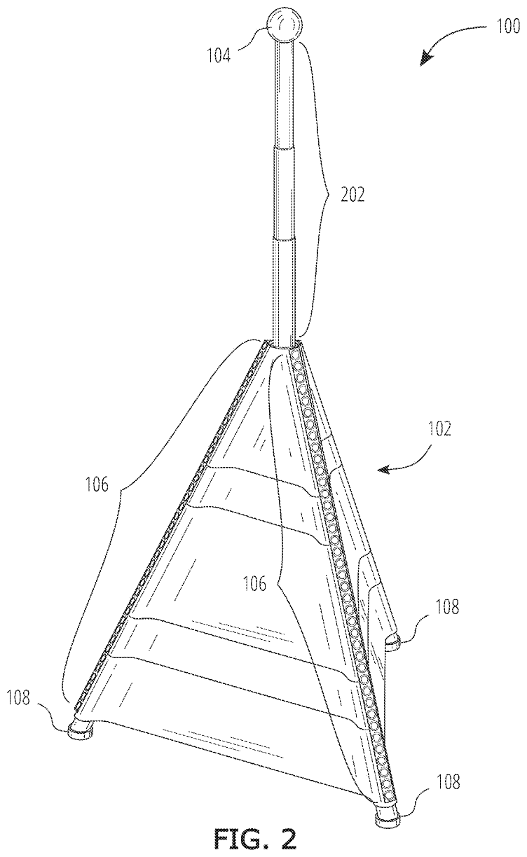

With reference to FIG. 2, an isometric side view is shown of the vehicle rooftop beacon 100, showing an embodiment that includes a telescoping mast 202 in an extended position. The telescoping mast 202 supports the light beacon 104 at an elevated position so as to increase the visibility of the light beacon 104 at a distance, and thereby increase the ability for emergency responders to locate the vehicle 502 (shown in FIG. 5). Both the light beacon 104 and the plurality of edge-mounted lights 106 increase the visibility of the vehicle 502 (FIG. 5) from a distance. In some embodiments, both the light beacon 104 and the plurality of edge-mounted lights 106 can be flashing lights so as to further increase visibility.

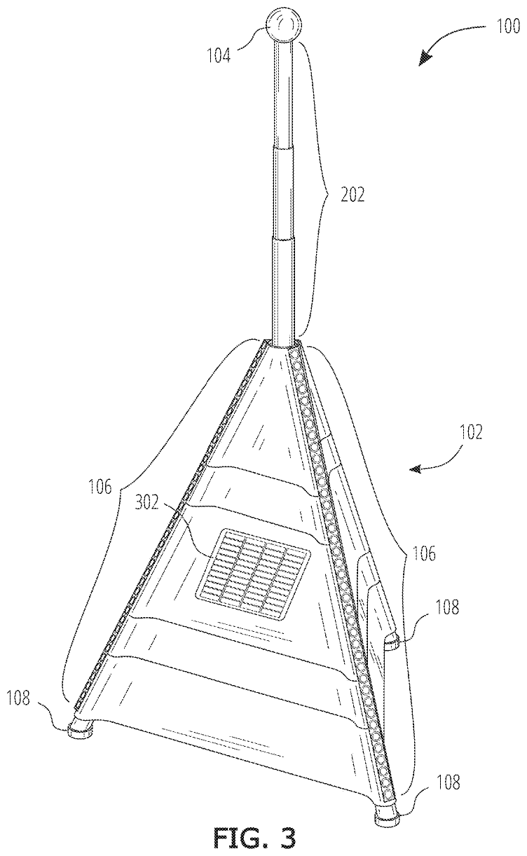

With reference to FIG. 3, an isometric side view is shown of the vehicle rooftop beacon 100, showing an embodiment that includes at least one solar panel 302 that provides electrical power from the sun. Also shown is the telescoping mast 202 in an extended position that supports the light beacon 104 at an elevated position so as to increase the visibility of the light beacon 104 from afar. Both the light beacon 104 and the plurality of edge-mounted lights 106 can be powered by the at least one solar panel 302.

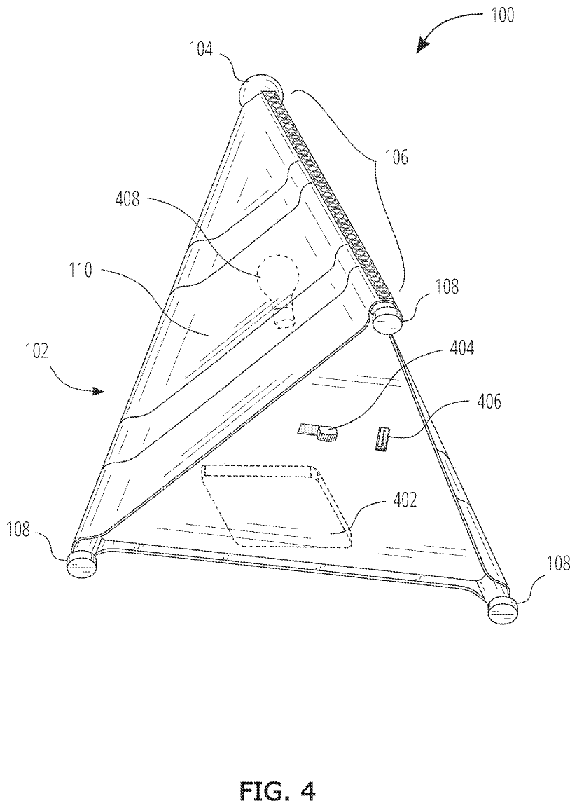

With reference to FIG. 4, an isometric bottom view is shown of the vehicle rooftop beacon 100. In this embodiment, the triangular side panels 110 are semi-transparent, and the base 102 includes at least one internal light 408 to further increase the visibility of the vehicle rooftop beacon 100. Electrical power to the light beacon 104, the plurality of edge-mounted lights 106, and the at least one internal light 408 is actuated by a switch 404. A USB port 406 can be used to recharge a battery 402, and the USB port 406 can also be used to connect to an external USB device (not shown) that can be powered by the battery 402, thereby providing an emergency source of electrical power to the external USB device, such as a cell phone (not shown).

With reference to FIG. 5, a perspective view is shown of the vehicle rooftop beacon 100 positioned on a rooftop 504 of a vehicle 502. The light beacon 104 is held in an elevated position by the telescoping mast 202 so as to increase the visibility of the light beacon 104 to emergency responders approaching from afar, thereby helping emergency responders to locate the vehicle 502. A secondary benefit of the light beacon 104 is that it illuminates an immediate vicinity 508 of the vehicle 502 for when the emergency responders arrive.

The plurality of edge-mounted lights 106 further increase the visibility of the rooftop beacon 100, and therefore increase the visibility of the vehicle 502. The plurality of edge-mounted lights 106 also further illuminate the vicinity 508 of the vehicle 502, and the vehicle 502 itself.

In this embodiment, the at least three support feet 108 contain magnets 114 (shown in FIG. 1B) to releasably attach to at least metallic portions of the vehicle surface 506 so as to stabilize the vehicle rooftop beacon 100 on the rooftop 504 in windy or otherwise stormy weather conditions.

Other modifications and implementations will occur to those skilled in the art without departing from the spirit and the scope of the invention as claimed. Accordingly, the above description is not intended to limit the invention, except as indicated in the following claims.

1. A vehicle rooftop beacon for indicating a location and enhancing visibility of a stopped vehicle to a remote approaching emergency vehicle at an earliest possible moment, the stopped vehicle having a rooftop, the vehicle rooftop beacon comprising:
a light beacon configured to be visible at a remote distance from the vehicle;
an extendable mast configured to elevate the light beacon; and
a base configured to be pyramidal in shape to support the extendable mast, the base having:
at least three support feet;
at least three triangular side panels each having two legs defined by, and secured to, a different pairing of each of the at least three support feet, and a triangular base side; and
a bottom panel having at least three sides, each of which is secured between the legs of a different one of the triangular panels and proximal to the triangular base sides thereof,
wherein the triangular side panels and the bottom panel together define a pyramidal volume within the base, and each of the support feet are configured to stabilize the base when placed on the rooftop of the vehicle.

2. The vehicle rooftop beacon of claim 1, wherein each of the support feet includes a magnet configured to removably attach the base to the vehicle.

3. The vehicle rooftop beacon of claim 1, wherein each of the support feet includes a weight configured to removably attach the base to the vehicle.

4. The vehicle rooftop beacon of claim 1, wherein each of the support feet includes a soft covering configured to protect the vehicle rooftop from being scratched.

5. The vehicle rooftop beacon of claim 1, wherein each of the support feet includes a rubbery surface configured to resist sliding off the vehicle rooftop and to protect the vehicle rooftop from being scratched.

6. The vehicle rooftop beacon of claim 1, wherein the at least three triangular side panels are formed of a unitary piece of material secured to the at least three support feet.

7. The vehicle rooftop beacon of claim 1, wherein at least one of the triangular side panels includes at least one solar panel for collecting electrical power when exposed to sunlight.

8. The vehicle rooftop beacon of claim 1, wherein the triangular side panels are semi-transparent, and the base includes at least one internal light disposed within the pyramidal volume.

9. The vehicle rooftop beacon of claim 1, wherein the extendable mast is a telescoping mast.

10. The vehicle rooftop beacon of claim 1, wherein the base includes a battery, disposed within the pyramidal volume, and configured to power at least the light beacon.

11. The vehicle rooftop beacon of claim 10, wherein the base includes a USB port configured to recharge the battery.

12. The vehicle rooftop beacon of claim 10, wherein the base includes a USB port configured to power an external USB device.

13. The vehicle rooftop beacon of claim 10, wherein electrical power from the battery to the light beacon is actuated by a switch.

14. The vehicle rooftop beacon of claim 1, wherein the light beacon includes a light emitting diode (LED).

15. The vehicle rooftop beacon of claim 10, wherein each triangular side panel of the base includes a plurality of lights mounted on an edge of the triangular side panel.

16. The vehicle rooftop beacon of claim 10, further including a plurality of lights mounted between the legs of each pair of the triangular side panels defined by each of the support feet.

17. The vehicle rooftop beacon of claim 1, wherein the at least three support feet and triangular side panels is equal to four thereof, and the base is shaped as a rectangular pyramid.

18. The vehicle rooftop beacon of claim 6, wherein the at least three support feet and triangular side panels is equal to three thereof, and the base is shaped as a triangular pyramid.

19. The vehicle rooftop beacon of claim 12, wherein the rectangular base is shaped as a square pyramid.

20. The vehicle rooftop beacon of claim 1, wherein the at least three support feet and triangular side panels is equal to six thereof, and the base is shaped as a hexagonal pyramid.
